(19) United States
(12) Patent Application Publication
(10) Pub. No.: US 2025/0060113 A1
(43) Pub. Date: Feb. 20, 2025

(54) DEVICE FOR CONTROLLING A SYSTEM FOR HEATING AND COOLING, AND CORRESPONDING METHOD

(71) Applicant: Danfoss A/S, Nordborg (DK)

(72) Inventors: Sinisa Bogar, Vrhnika (SI); Miran Muhic, Ljubljana (SI); Derek Foong King Soon, Petaling Jaya (MY)

(21) Appl. No.: 18/804,268

(22) Filed: Aug. 14, 2024

(30) Foreign Application Priority Data
Aug. 16, 2023 (DK) PA202330154

(51) Int. Cl. F24D 19/10; F24F 11/84; G05D 7/06

(52) U.S. Cl. CPC F24D 19/1021; F24F 11/84; G05D 7/0635; F24D 2220/044

(57) ABSTRACT

A device (10) for controlling a system (30) for heating and cooling including at least one valve actuator (12) for a valve (14) of a bypass line (16) of the system (30), and a flow measuring device (20) for a return line (18) of the system (30), the return line (18) leading a combined flow from the bypass line (16) and a heating or cooling device return line (32) from at least one heating or cooling device (22) to at least one thermal energy source (24), the flow measuring device (20) being configured to determine and provide at least one actual flow value of the combined flow, wherein the valve actuator (12) is configured to receive the actual flow value and to control the valve (14) based on the actual flow value. The disclosure provides a device (30) to control a system for heating or cooling that is easier to handle and has reduced costs.

### CROSS-REFERENCE TO RELATED APPLICATION

This application claims foreign priority benefits under 35 U.S.C. § 119 to Danish Patent Application No. PA202330154 filed on Aug. 16, 2023, the content of which is hereby incorporated by reference in its entirety.

### TECHNICAL FIELD

The invention relates to a device for controlling a system for heating and cooling, and a corresponding method.

### BACKGROUND

Systems for heating and cooling are used to heat or cool buildings or devices. The systems comprise thermal energy sources, which may heat or cool a fluid, which is pumped through. The fluid being output from the thermal energy sources is provided to consumer devices via a supply line. In the consumer device, the fluid provides heating or cooling, respectively. After passing the consumer devices, the fluid is returned to the thermal energy source via a return line. For an optimal operation of the thermal energy sources, minimum input flow of fluid is required, i.e. a minimum flow in the return line is required. To provide a minimum flow in the return line in case the consumer devices are switched off or temporary do not require fluid for heating or cooling, a bypass line connects the supply line and the return line, bypassing the consumer devices. The flow in the bypass line may be controlled with a valve.

From EP 2 307 938 B2, a system is known, having a flow sensor being attached to the bypass line and a controller to control the valve of the bypass line. The controller receives the measured flow values from the flow sensor. Then, the controller determines a valve position for a flow in the bypass line and provides that valve position to an actuator of the valve.

There is a need to provide an improved system for heating and cooling, a device for controlling that system, and an improved method to control the system that is easier to handle and has reduced costs.

### SUMMARY

Claims 1, 6 and 7 indicate the main features of the invention. Features of embodiments of the invention are subject of claims 2 to 5 and 8.

In an aspect of the invention, a device for controlling a system for heating and cooling is provided, the device comprising at least one valve actuator for a valve of a bypass line of the system, and a flow measuring device for a return line of the system, e.g. a flow sensor, a flow meter, or a thermal energy meter, the return line leading a combined flow from the bypass line and a heating or cooling device return line from at least one heating or cooling device to at least one thermal energy source, the flow measuring device being configured to determine and provide at least one actual flow value of the combined flow, wherein the valve actuator is configured to receive the actual flow value and to control the valve based on the actual flow value.

According to the invention, the device uses the flow value of the combined return flow of the bypass line and the heating or cooling device return line from the heating or cooling device to control the flow in the bypass line. Thus, the device provides an accurate control of the flow to the thermal energy source and can provide a minimum flow in the return line using the valve. The flow measuring device is configured to be arranged on a return line of a system for cooling and heating, wherein the valve actuator is configured to control a valve of a bypass line, for example by controlling the opening position of the valve. Particularly, the flow measuring device is configured to be arranged at a position on the combined return line, where the flow from the bypass line and the heating or cooling device flow together. Therefore, the valve actuator receives the actual flow value from the combined flow from the bypass line and the heating or cooling device to the thermal energy source. Furthermore, the valve actuator is configured to process the actual flow value to provide the control of the valve of the bypass line. Hence, the valve actuator and the flow measuring device comprise a direct signal connection between each other. The device does not require an external controller for the valve actuator for processing the actual flow values from the flow measuring device. This reduces the costs of the device. Due to the control of the valve in the bypass line with the actual flow values of the combined flow from the bypass line and the heating or cooling device to the thermal energy source, the flow in the bypass line can be adjusted to meet desired flow to the heat exchanger, accurately. Furthermore, if the heating or cooling device do not provide flow into the return line, the valve in the bypass line can be controlled such that the bypass line provides sufficient flow to meet the minimum flow requirements of the thermal energy sources. Thus, the device provides an easy handling of a system for heating or cooling.

In an example, the thermal energy source may be a heat exchanger particularly a chiller or a heat pump or similar. The heating or cooling device may for example be a fan coil unit, air handling unit, radiant panels, chilled beams and similar.

In an example, the valve actuator may be configured to provide a minimum flow in the return line by controlling the flow in the bypass line.

The valve actuator may therefore process the actual flow values such that the bypass line contributes a flow being sufficient to meet a predefined set point flow for the combined flow in the return line.

In another example, the valve actuator may further be configured to receive a minimum return flow value, to check whether the actual flow value is above the minimum return flow value, if the actual flow value is above the minimum return flow value to control the valve based on the minimum return flow value.

In a further example, the valve actuator may comprise a motor connected to the valve and a processing unit for receiving the actual flow value and for providing at least one motor position value for the motor based on the actual flow value.

For example, the calculated set point flow value being provided by the PID controller mentioned above may be converted to a motor position value for the motor of the valve actuator to control the valve opening position.

For example, the processing unit may further comprise a PID controller to control the valve, particularly based on the minimum flow value for the combined flow in the return line.

The input of the PID controller may be the difference between the minimum flow value and the actual flow value. The output of the PID controller may be a calculated set point flow value.

In a second aspect of the invention, a system for heating or cooling is provided, the system comprising at least one device according to the preceding description, at least one thermal energy source, at least one heating or cooling system, at least one supply line fluidly connecting an output of the thermal energy source and an input of the heating or cooling system, at least one return line fluidly connecting an output of the heating or cooling system and an input of the thermal energy source, at least one bypass line fluidly connecting the supply line and the return line in parallel connection to the heating or cooling device return line from at least one heating or cooling device, and at least one valve being mounted in the bypass line for controlling the flow in the bypass line, the valve actuator being mounted on the valve to control the valve, wherein the flow measuring device is mounted on the return line to communicate flow data to the valve actuator.

The effects and further embodiments of the system according to the present invention are analogous to the effects and embodiments of the device according to the description mentioned above. Thus, it is referred to the above description of the device.

In a third aspect of the invention, a method for controlling a system for heating or cooling according to the preceding description is provided, the method comprising at least the following steps: determine at least one actual flow value of a combined flow from the bypass line and the heating or cooling device to the thermal energy source using the flow measuring device; receive the at least one actual flow value with the valve actuator; and control the valve based on the actual flow value using the valve actuator.

In an example, the method may further comprise the steps: receive a minimum flow value with the valve actuator, check whether the actual flow value is above the minimum flow value with the valve actuator, if the actual flow value is above the minimum flow value: control the valve based on the minimum flow value with the valve actuator.

The steps: check whether the actual flow value is above the minimum flow value with the valve actuator, if the actual flow value is above the minimum flow value: control the valve based on the minimum flow value with the valve actuator may for example be sub-steps of the step control the valve based on the actual flow value using the valve actuator.

The effects and further embodiments of the method according to the present invention are analogous to the effects and embodiments of the device and the system according to the description mentioned above. Thus, it is referred to the above description of the device and the system.

### BRIEF DESCRIPTION OF THE DRAWINGS

Further features, details and advantages of the invention result from the wording of the claims as well as from the following description of exemplary embodiments based on the drawings. The figures show:

FIG. 1 a schematic drawing of the system heating and cooling with the device for controlling the system; and

FIG. 2 a flow chart of the method for controlling the system.

### DETAILED DESCRIPTION

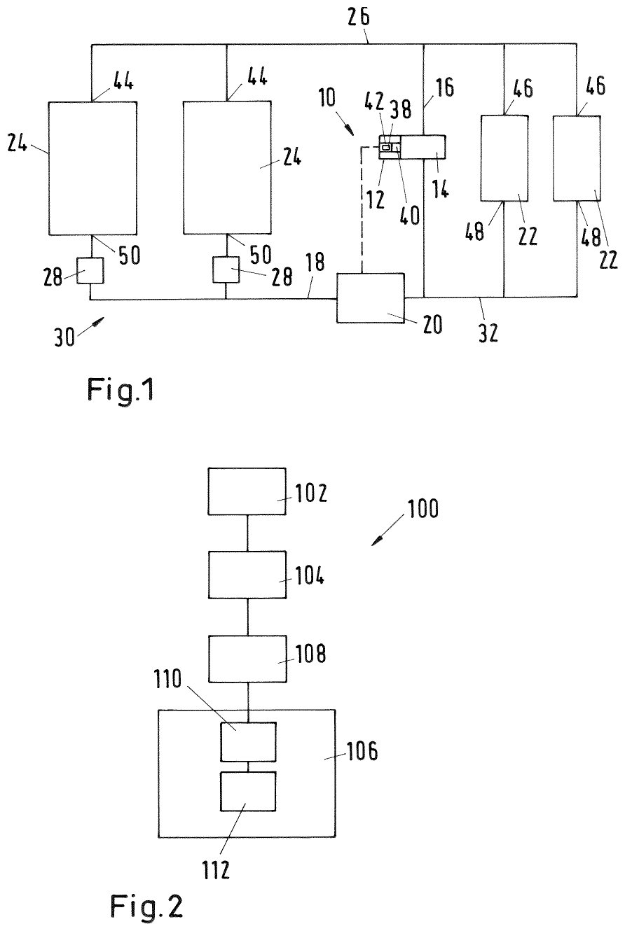

FIG. 1 shows a schematic drawing of an example of a system 30 for heating and cooling. The system 30 comprises at least one heating and cooling device 22, which may also be called consumer device. In this example, the system 30 comprises two heating and cooling devices 22. Each heating and cooling device 22 comprises an input 46 and an output 48.

Furthermore, the system 30 comprises at least one thermal energy source 24, wherein in this example, the system 30 comprises two thermal energy sources 24. Each thermal energy source 24 comprises an input 50 and an output 44 for a heating or cooling fluid.

The system 30 further comprises a supply line 26 fluidly connecting the output 44 of the thermal energy source 24 to the input 46 of the heating or cooling device 22 and a heating and cooling device return line 32 fluidly connecting the all outputs 48 of the heating or cooling devices 22 to a combined return line 18. The combined return line 18, combines the flow from the bypass line 16 and the heating or cooling device return line 32 from the heating and cooling device 22 to the input 50 of the thermal energy source 24.

Furthermore, the system 30 further comprises a bypass line 16 fluidly connecting the supply line 26 to the combined return line 18. The bypass line 16 bypasses the heating or cooling devices 22 and comprises a valve 14. The valve 14 controls the flow in the bypass line 16. For example, an opening position of the valve 14 may control the flow, i.e. the wider the opening position of the valve 14, the higher the flow in the bypass line 16.

The valve 14 may be arranged in the bypass line 16 such that the valve 14 interrupts the bypass line 16. Thus, the valve 14 may be configured such that it does not directly control the flow to the inputs 46 of the heating or cooling devices 22.

The system 30 further comprises a device 10 for controlling the system 30. The device 10 comprises a valve actuator 12 and a flow measuring device 20.

The flow measuring device 20 is arranged on the return line 18 at a position leading a combined flow from the bypass line 16 and the heating or cooling device return line 32 from the heating or cooling device 22 to the thermal energy source 24. Thus, the flow measuring device 20 measures the flow being provided to the input 50 of the thermal energy source 24.

Furthermore, the flow measuring device 20 may provide actual flow values indicating the actual flow of the combined flow in the return line 18.

The flow measuring device 20 provides the actual flow value to the valve actuator 12, directly.

The flow measuring device 20 may for example use an ultrasonic, electromagnetic, or mechanical measurement element or others, to determine the actual flow value in the return line 18. The flow measuring device 20 may be a flow sensor, a flow meter or a thermal energy meter.

The valve actuator 12 is attached to the valve 14. Furthermore, the valve actuator 12 may comprise a motor 40 to change the opening position of the valve 14. A processing unit 42 of the valve actuator 12 may provide motor position values determined from the actual flow measuring values from the flow meter device 20.

The processing unit 42 may for example be a microcontroller of the valve actuator 12. Furthermore, the processing unit 42 may comprise a PID 38.

FIG. 2 shows a flow chart of the method 100 for controlling the system for heating or cooling according to the description mentioned above.

In a step 102, at least one actual flow value of a combined flow from the bypass line and the heating and cooling device to the thermal energy source of the system is determined. The determination is performed using the flow meter device arranged on the return line of the system. The flow meter device measures the input flow of the at least one thermal energy source. Furthermore, the flow meter device may provide actual flow data.

The valve actuator of the system receives the actual flow value in a step 104. Thus, the steps 102 and 104 may be performed at the same time and repeatedly.

In an optional step 108, the valve actuator may receive a minimum flow value. This value may be used with the actual flow values to provide motor position values for controlling the valve in the bypass line.

In a further step 106, the valve actuator controls the valve in the bypass line based on the minimum flow value.

In an optional sub-step 110 of step 106, the valve actuator may check whether actual flow value is higher than the minimum flow value. If the actual flow value is above the minimum flow value, the valve actuator may control the valve based on the difference between the minimum flow value and the actual flow value according to a further optional sub-step 112.

The invention is not limited to one of the aforementioned embodiments. It can be modified in many ways.

All features and advantages resulting from the claims, the description and the drawing, including constructive details, spatial arrangements and procedural steps, may be essential for the invention both in themselves and in various combinations.

While the present disclosure has been illustrated and described with respect to a particular embodiment thereof, it should be appreciated by those of ordinary skill in the art that various modifications to this disclosure may be made without departing from the spirit and scope of the present disclosure.

1. A device for controlling a system for heating and cooling, the device comprising at least one valve actuator for a valve of a bypass line of the system, and a flow measuring device for a return line of the system, the return line leading a combined flow from the bypass line and a heating or cooling device return line from at least one heating or cooling device to at least one thermal energy source, the flow measuring device being configured to determine and provide at least one actual flow value of the combined flow, wherein the valve actuator is configured to receive the actual flow value and to control the valve based on the actual flow value.

2. The device according to claim 1, wherein the valve actuator is configured to provide a minimum flow in the return line by controlling the flow in the bypass line.

3. The device according to claim 1, wherein the valve actuator is further configured to receive a minimum return flow value, to check whether the actual flow value is above the minimum flow value, if the actual flow value is above the minimum flow value to control the valve based on the minimum flow value.

4. The device according to claim 1, wherein the valve actuator comprises a motor connected to the valve and a processing unit for receiving the actual flow value and for providing at least one motor position value for the motor based on the actual flow value.

5. The device according to claim 4, wherein the processing unit comprises a PID controller to control the valve.

6. A system for heating or cooling, the system comprising at least one device according to claim 1, at least one thermal energy source, at least one heating or cooling system, at least one supply line fluidly connecting an output of the thermal energy source and an input of the heating or cooling system, at least one return line fluidly connecting an output of the heating or cooling system and an input of the thermal energy source, at least one bypass line fluidly connecting the supply line and the return line in parallel connection to a heating or cooling device return line from the at least one heating or cooling device, and at least one valve being mounted in the bypass line for controlling the flow in the bypass line, the valve actuator being mounted on the valve to control the valve, wherein the flow measuring device is mounted on the return line to communicate flow data to the valve actuator.

7. A method for controlling a system for heating or cooling according to claim 6, the method comprising at least the following steps:
determine at least one actual flow value of a combined flow from the bypass line and the heating or cooling device to the thermal energy source using the flow measuring device;
receive the at least one actual flow value with the valve actuator; and
control the valve based on the actual flow value using the valve actuator.

8. The method according to claim 7, wherein the method further comprises the steps:
receive a minimum flow value with the valve actuator,
check whether the actual flow value is above the minimum flow value with the valve actuator,
if the actual flow value is above the minimum flow value: control the valve based on the difference between the minimum flow value and the actual flow value with the valve actuator.

9. The device according to claim 2, wherein the valve actuator is further configured to receive a minimum return flow value, to check whether the actual flow value is above the minimum flow value, if the actual flow value is above the minimum flow value to control the valve based on the minimum flow value.

10. The device according to claim 2, wherein the valve actuator comprises a motor connected to the valve and a processing unit for receiving the actual flow value and for providing at least one motor position value for the motor based on the actual flow value.

11. The device according to claim 3, wherein the valve actuator comprises a motor connected to the valve and a processing unit for receiving the actual flow value and for providing at least one motor position value for the motor based on the actual flow value.

12. A system for heating or cooling, the system comprising at least one device according to claim 2, at least one thermal energy source, at least one heating or cooling system, at least one supply line fluidly connecting an output of the thermal energy source and an input of the heating or cooling system, at least one return line fluidly connecting an output of the heating or cooling system and an input of the thermal energy source, at least one bypass line fluidly connecting the supply line and the return line in parallel connection to a heating or cooling device return line from the at least one heating or cooling device, and at least one valve being mounted in the bypass line for controlling the flow in the bypass line, the valve actuator being mounted on the valve to control the valve, wherein the flow measuring device is mounted on the return line to communicate flow data to the valve actuator.

13. A system for heating or cooling, the system comprising at least one device according to claim 3, at least one thermal energy source, at least one heating or cooling system, at least one supply line fluidly connecting an output of the thermal energy source and an input of the heating or cooling system, at least one return line fluidly connecting an output of the heating or cooling system and an input of the thermal energy source, at least one bypass line fluidly connecting the supply line and the return line in parallel connection to a heating or cooling device return line from the at least one heating or cooling device, and at least one valve being mounted in the bypass line for controlling the flow in the bypass line, the valve actuator being mounted on the valve to control the valve, wherein the flow measuring device is mounted on the return line to communicate flow data to the valve actuator.

14. A system for heating or cooling, the system comprising at least one device according to claim 4, at least one thermal energy source, at least one heating or cooling system, at least one supply line fluidly connecting an output of the thermal energy source and an input of the heating or cooling system, at least one return line fluidly connecting an output of the heating or cooling system and an input of the thermal energy source, at least one bypass line fluidly connecting the supply line and the return line in parallel connection to a heating or cooling device return line from the at least one heating or cooling device, and at least one valve being mounted in the bypass line for controlling the flow in the bypass line, the valve actuator being mounted on the valve to control the valve, wherein the flow measuring device is mounted on the return line to communicate flow data to the valve actuator.

15. A system for heating or cooling, the system comprising at least one device according to claim 5, at least one thermal energy source, at least one heating or cooling system, at least one supply line fluidly connecting an output of the thermal energy source and an input of the heating or cooling system, at least one return line fluidly connecting an output of the heating or cooling system and an input of the thermal energy source, at least one bypass line fluidly connecting the supply line and the return line in parallel connection to a heating or cooling device return line from the at least one heating or cooling device, and at least one valve being mounted in the bypass line for controlling the flow in the bypass line, the valve actuator being mounted on the valve to control the valve, wherein the flow measuring device is mounted on the return line to communicate flow data to the valve actuator.
